(19) United States
(12) Patent Application Publication
(10) Pub. No.: US 2026/0169313 A1
(43) Pub. Date: Jun. 18, 2026

(54) ULTRALIGHT EYEWEAR DEVICES UTILIZING OPTICAL ELEMENTS WITH INTEGRATED CONDUCTIVE TRACES

(71) Applicant: GOOGLE LLC, Mountain View, CA (US)

(72) Inventors: Joshua Moore, Elora (CA); Daniel J. Effinger, Squamish (CA)

(21) Appl. No.: 19/422,598

(22) Filed: Dec. 17, 2025

Related U.S. Application Data
(60) Provisional application No. 63/735,133, filed on Dec. 17, 2024.

(51) Int. Cl. G02C 11/00; G02B 27/01; G02C 1/02; G02C 5/00; G02C 5/14

(52) U.S. Cl. CPC G02C 11/10; G02C 1/02; G02C 5/001; G02C 5/146; G02B 27/0176; G02B 2027/0178

(57) ABSTRACT

An eyewear device includes a support frame comprising a first frame component and a second frame component, the first frame component housing an electrical component, and an optical element mechanically coupled to the first frame component at a first side and to the second frame component at an opposing second side. The eyewear device further includes a conductive trace disposed at a surface of the optical element, the conductive trace extending across the optical element between the first side and the second side to provide a conductive pathway between the first frame component and the second frame component. A method of operating the eyewear device includes transmitting an electrical signal between the first frame component and the second frame component via the conductive trace. The first frame component can include a temple, and the second frame component can include a bridge or another temple.

### BACKGROUND

Augmented reality (AR) glasses and other eyewear devices are wearable near-eye display devices that integrate digital information and functionality into eyewear having an eyeglasses form factor or similar form factor. These devices typically incorporate various electronic components, such as processors, batteries, displays, sensors, and communication modules, distributed throughout the support frame. The integration of these components allows eyewear devices to provide features like AR displays, audio playback, voice commands, and connectivity with other devices. In conventional designs, the electronic subsystems are often spread across different parts of the support frame, including the left and right temples and shoulder enclosures. This distribution helps balance the weight and utilize available space for incorporating the various electrical, optical, and audio components. However, for the eyewear devices to function as a cohesive system, these distributed components typically need to be electrically connected to enable shared functionality, such as power distribution, communication between components, charging, sensor data fusion, and audio synchronization.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a perspective view of an eyewear device with an ultralight glasses form factor and with lenses or other optical elements incorporating conductive traces for providing conductive pathways across the optical elements according to some aspects.

FIG. 2 depicts a front view of the eyewear device of FIG. 1 and includes a depiction of the physical connectors that connect right and left temples to the two lenses, and connect the two lenses via a bridge connector, according to some aspects.

FIG. 3 illustrates a cross-section representation of the eyewear device of FIGS. 1 and 2 in accordance with some aspects.

FIG. 4A illustrates an exploded view of an example optical element with integrated conductive traces and two lens receptacles in accordance with some embodiments.

FIG. 4B illustrates an enlarged view of a lens tab of the optical element of FIG. 4A in accordance with some embodiments.

FIGS. 5A and 4B illustrate perspective views of an example optical element incorporating integrated conductive traces in accordance with some aspects.

FIG. 6 illustrates a method of operation of the eyewear device of FIGS. 1-5B in accordance with some aspects.

### DETAILED DESCRIPTION

As the name suggests, “smartglasses” employ common eyeglasses form factors to provide enhanced functionality in a device that assumes a conventional eyeglasses shape. Full-framed eye glass form factors offer a full frame in which the various electrical, optical, and mechanical subsystems of the smartglasses can be enclosed and hidden, including the electrical connections between the electrical subsystems. Conventionally, the electrical connections between the left and right sides of the frame of a full-frame eyewear device, or between one side of the frame and a center section of the frame (that is, the bridge), have been achieved through the use of flexible printed circuit boards (PCBs), commonly referred to as “flex circuits.” These flex circuits are typically long, thin, and flexible, and are uniquely shaped to accommodate the specific design of each eyewear device model. In some cases, multiple flex circuits may be used for different purposes, such as dedicated camera connections, power lines, or radio frequency (RF) antenna connections. However, the use of flex circuits in eyewear device design presents several challenges. The unique and complex shapes of these flex circuits often result in poor manufacturing efficiency and high production costs. Additionally, the need to accommodate and conceal these flex circuits within the frame structure has historically limited the range of feasible frame styles, particularly for lightweight and minimalist designs.

Ultralight eyewear, which includes metal frame eyewear, rimless eyewear, and semi-rimless eyewear, presents additional challenges for the integration of electronic or electro-optical functionality due to the difficulties in routing and concealing the necessary electrical connections between components, given the absence of a full frame or the use of a metal frame. To address the challenges associated with traditional flex-based architectures in ultralight eyeglasses form factors, the present disclosure describes systems and techniques for supporting electrical connections between components of an eyewear device in which the optical elements, such as waveguides or lenses of the eyewear device themselves are utilized to transfer electrical signals from one side (or temple) of the frame to the other or from one side of the frame to a bridge portion of the frame. In particular, embodiments of the present disclosure include the integration of conductive pathways directly onto or into the optical elements, which can eliminate or reduce the need for flex circuits spanning between the temples of the frame. This approach significantly reduces mass and enables the adoption of highly desirable “ultralight” form factors, including rimless and semi-rimless eyeglass form factors.

Aspects of this approach may utilize specific conductive technologies to facilitate these lens-based connections, such as Indium Tin Oxide (ITO) or Laser Direct Structuring (LDS). To illustrate, transparent ITO conductors may be deposited and patterned on one or both of the optical elements to facilitate the transmission of low-current electrical signals between temples or between a temple and the bridge in a manner that is transparent or nearly transparent to the user and casual observers. For higher-demand connections, such as power transfer from a battery or impedance-controlled high-frequency signals, LDS can be used to create three-dimensional conductive traces composed of, for example, copper, gold, or nickel (or some combination thereof), on the lens edges and faces. While more visible than typical ITO traces, such LDS traces typically permit higher power transfer and, given their often metallic or shiny appearance, can also be dual-purposed to provide cosmetic embellishment in addition to providing conductive pathways between sides of the frame.

In some embodiments, the system further includes physical lens receptacles at the temples and bridge and which mate with the conductive traces at the lens edges as well as provide mechanical coupling between the frame and the lenses. These physical lens receptacles treat the lens edges similarly to printed circuit board assembly (PCBA) edge connectors or card edge connectors for providing electrical and mechanical connectivity, and may utilize features like drill holes, tabs, pins, or slots for alignment and security. This configuration allows the lenses to bridge the gap mechanically and electrically between the left and right temple structures without the need for an encapsulating frame. Alternatively, solder pad connections may be utilized to provide a more secure electrical connection between lens receptacle and the integrated conductive traces of the lens.

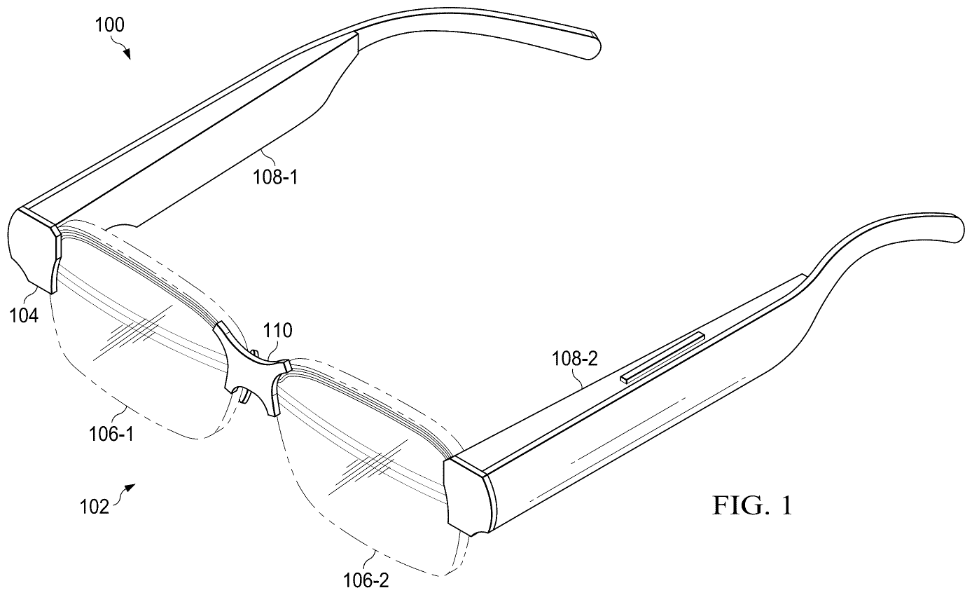

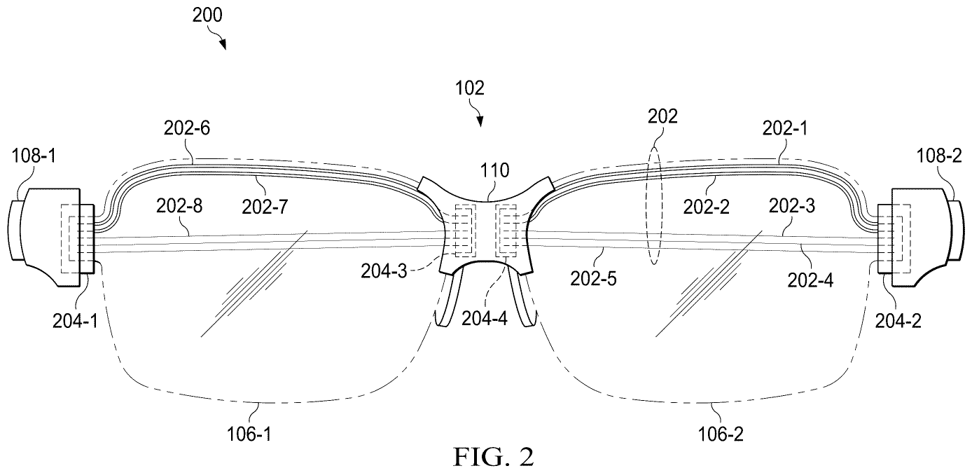

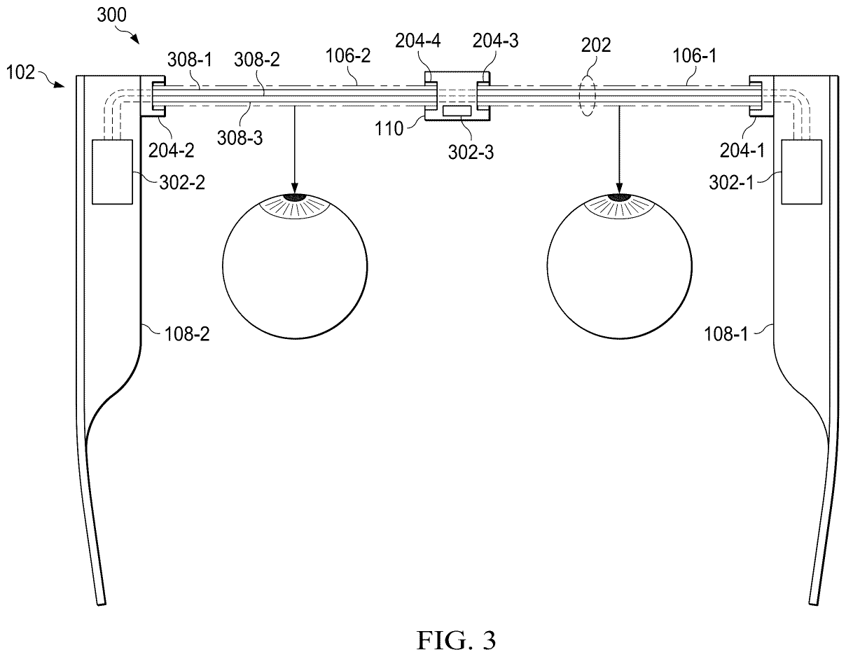

Referring now to FIGS. 1 to 3, a perspective front view 100, front view 200, and cross-sectional representational view 300, respectively, of an eyewear device 102 employing integrated conductive traces in one or both optical elements for cross-frame conductivity are illustrated in accordance with some aspects. For ease of reference, elements depicted for the eyewear device 102 in FIGS. 1 to 3 are numbered according to the figure in which they are first clearly depicted, with elements first clearly depicted in FIG. 1 being numbered “1XX”, elements first clearly depicted in FIG. 2 being numbered “2XX”, and elements first clearly depicted in FIG. 3 being numbered “3XX.”

The eyewear device 102 includes a support frame 104 configured to support and contain two optical elements 106: a right-eye optical element 106-1 and a left-eye optical element 106-2. Note that the orientation terms “left” and “right” are utilized herein with reference to the wearer's perspective. In the depicted example, the eyewear device 102 has a rimless eyeglasses form factor and thus the support frame 104 includes a right-side temple 108-1 and a left-side temple 108-2, and a bridge 110, with the temple 108-1 mechanically attached to a right edge of the optical element 106-1, the temple 108-2 mechanically attached to a left edge of the optical element 106-2, and the bridge 110 mechanically connected to the left edge of the optical element 106-1 and the right edge of the optical element 106-2. In other embodiments, the eyewear device 102 may employ a semi-rimless form factor with, for example, a thin plastic or metal support extending between the temples 108-1, 108-2 via the bridge 110, or a metal rim form factor with a thin metal rim extending between the temples 108-1, 108-2 and incorporating the bridge. Regardless, of the particular form factor, it should be understood that the eyewear device 102 includes an “ultralight” form factor that makes the implementation of flex circuits that span between the temples 108 or span between a temple 108 and the bridge 110 impracticable, such as due to the lack of sufficient space within the rim of the support frame 104 to incorporate a suitable flex circuit for the conductive pathways to be employed.

The optical elements 106 comprise transparent optical elements configured to transmit light from the surrounding environment to the corresponding eye of a user (that is, the optical elements 106 are “see-through”), and depending on implementation, may provide additional functionality, such as lensing (the focusing or dispersion of the incident light), implementation of a waveguide (e.g., reflective or diffractive) for display of generated imagery, display of illuminated, fixed logos or icons, and the like. For ease of reference and with deference to colloquial usage, these optical elements 106 are also referred to herein as “lens 106-1”, “lens 106-2”, and “lenses 106” collectively, but such usage does not necessarily require lensing functionality (e.g., the focusing or dispersion of incident light) or other ophthalmic functionality unless specifically noted.

Two or more of the temple 108-1, the temple 108-2, or the bridge 110 house or otherwise utilize electrical components to provide various functionality for the eyewear device 102. To illustrate, in the example of cross-section view 300 of FIG. 3, the eyewear device 102 includes electrical componentry 302-1 in the right-side temple 108-1, electrical componentry 302-2 in the left-side temple 108-2, and further may include electrical componentry 302-3 in the bridge 110. Examples of such electrical components implemented in one or more of the electrical componentry 302-1, 302-2, or 302-3 include, but are not limited to, batteries, power regulators, processors, memory and other storage, light engines (e.g., microLED displays, liquid crystal on silicon (LCoS) displays, and the like), cameras, microphones, touchpads, capacitive switches, and other sensors, radio frequency (RF) antennas, infrared (IR) light sources and drivers, speakers, and the like.

Often, there is a need to provide electrical pathways between the electrical componentry 302-1, 302-2, and 302-3. For example, in some instances, the battery for the eyewear device 102 may be housed in one temple, and thus conductive pathways are needed for providing electrical power to electrical components in the other temple or to electrical components found in the bridge 110. As another example, both temples may house corresponding display engines for projecting generated imagery via the lenses 106-1 and 106-2, but the processing system that generates the imagery and the control signals to control the display engines to generate light representing such imagery may be located in only one temple, thereby necessitating conductive pathways between this temple and the other temple for transmitting data signaling to the display engine located in or proximate to the temple without the processing system. As yet another example, an IR camera may be located in the bridge 110 and thus necessitating one or more conductive pathways between the bridge 110 and the temple 108 housing the processing system that processes data from the IR camera so as to transmit data between the IR camera and this processing system.

In conventional systems, the rim of the glasses frame serves to house and conceal flex circuits that provide such conductive pathways between temples and/or between temple and bridge. However, the eyewear device 102 has an ultralight form factor and thus lacks an encapsulating rim with sufficient volume to contain and conceal such flex circuits. Thus, to facilitate electrical coupling between the temples 108 and/or between the temples 108 and the bridge 110, and the electrical componentry contained therein, one or both of the lenses 106-1 and 106-2 themselves are configured to implement electrical pathways that extend laterally across the corresponding lens to complete electrical connections between the bridge 110 and the adjacent temple structure, and thus facilitate electrical pathways between the two temples 108-1, 108-2 via the lenses 106-1, 106-2 and the bridge 110 (or between the bridge 110 and one of the temples 108 via one of the lenses 106).

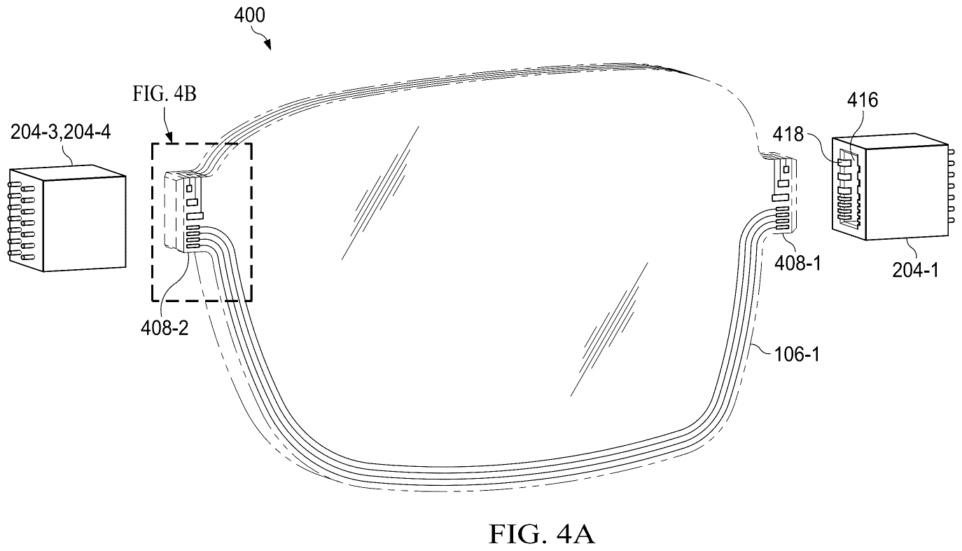

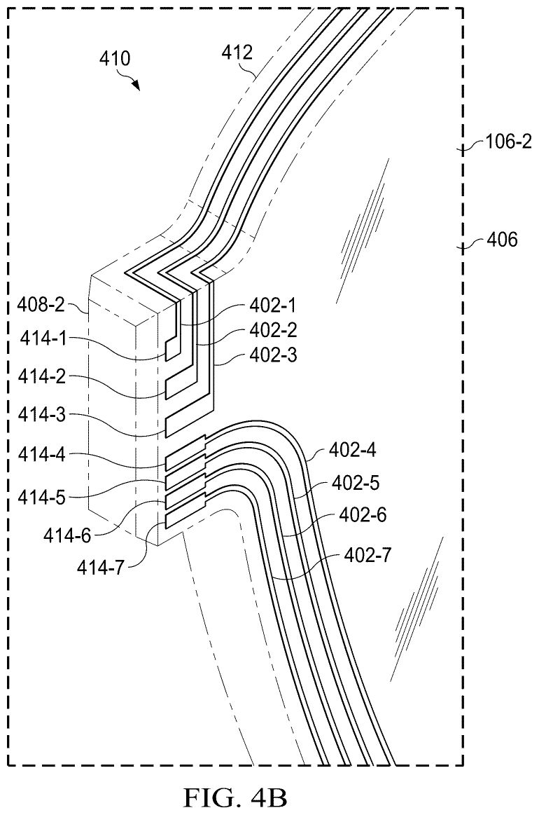

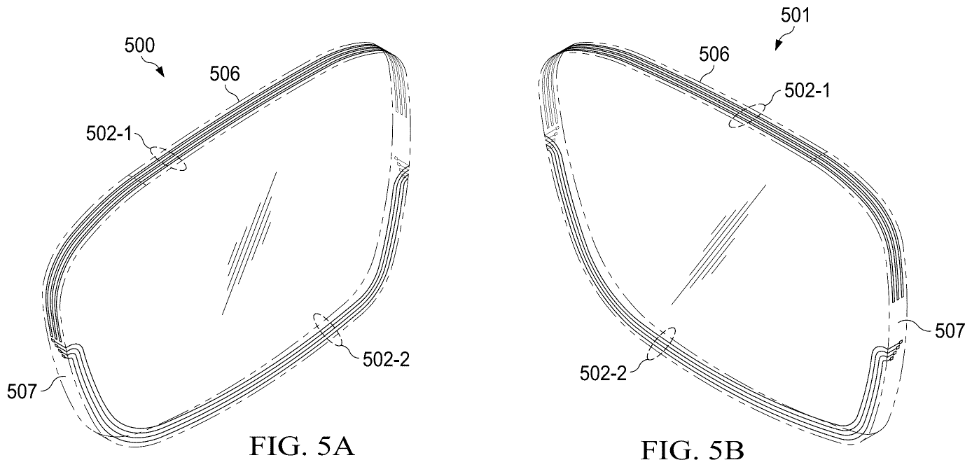

In some embodiments, such conductive traces (referred to herein collectively as conductive traces 202) are integrated with the lens 106 via patterning or other formation of a conductive trace 202 at one or more surfaces of the lens, with the conductive trace 202 composed of one or more metals, metal alloys, or other conductive materials that span across the lateral extent of the lens 106. For example, in some implementations, a lens 106 is fabricated to integrate one or more conductive traces 202 formed using a Laser Direct Structuring (LDS) process, in which a three-dimensional (3D) conductive traces (e.g., conductive traces 202-1, 202-2 for lens 106-2) composed of copper (Cu), gold (Au), silver (Ag), or other conductive metals or combinations thereof, are patterned on one or both of an edge or a face of the lenses and plated to increase the metal traces to the intended thickness. Because LDS-generated conductive traces can carry relatively high currents, LDS-generated conductive traces in the lenses 106 can be used to, for example, supply power or for higher-voltage/higher-current signaling. LDS also has the advantage of being readily patterned around corners and on multiple surfaces continuously, allowing use of patterning on the edge of the lens 106 and transitioning to the face of the lens for presenting interconnect features, as described below. While being well-suited for power transmission or high-voltage/high-current uses, LDS-formed conductive traces may be observable to the wearer or to an external observer, and thus, in embodiments, the design of the lens 106 generally will avoid formation of LDS-formed conductive traces in the direct line of sight of the wearer, and would instead generally locate LDS-formed conductive traces either along the top or bottom of the face of the lens 106, or on the edge of the lens 106 as described in greater detail below with reference to FIGS. 4A, 4B, 5A, and 5B. Moreover, their visibility can be leveraged by patterning one or more LDS-formed conductive traces to also present some form of cosmetic embellishment, such as a Greek key pattern, that may be aesthetically appealing.

As another example, the lens 106 can be fabricated to integrate one or more conductive pathways formed from Indium Tin Oxide (ITO) (e.g., conductive traces 202-3, 202-4, 202-5). In this approach, a relatively thin layer of ITO is deposited and patterned on a surface of the lens in the shape of the desired conductive trace. The resulting structure is effectively optically transparent and is electrically conductive. The width of such conductive traces can be increased at one or both termini so as to present contact interface pads. As they are effectively invisible to the wearer or to an observer, ITO-formed conductive traces may be formed on the lens 106 in the direct line of sight of the wearer without unnecessarily distracting the wearer. However, ITO-formed conductive traces typically are limited to relatively low voltage/low current uses and thus may be limited to data signaling uses rather than for power distribution.

To facilitate completion of conductive pathways between the electrical componentry via the conductive traces 202 integrated into one or both of the lenses 106, the support frame 104 may implement lens receptacles 204 to mechanically couple a corresponding edge of a lens 106 to a component of the support frame 104 as well as to provide electrical coupling between the component of the support frame and the contact pads of the conductive traces present at that edge of the lens 106. To illustrate, in the embodiment of FIGS. 1-3, the support frame 104 includes a lens receptacle 204-1 to provide physical and electrical coupling between the right side of the lens 106-1 and the right-side temple 108-1, a lens receptacle 204-2 to provide physical and electrical coupling between the left side of the lens 106-2 and the left-side temple 108, and lens receptacles 204-3 and 204-4 at the bridge 110 to provide mechanical and electrical coupling between the right side of the lens 106-1 and the bridge 110 and the left side of the lens 106-2 and the bridge 110, respectively. The physical coupling, or mating, of a lens receptacle 204 to a corresponding lens (as well as alignment thereof) can be implemented using clamping (e.g., via spring-loaded clamps or spring-loaded pins), tabs, slots, screws, bolts, and the like.

In some embodiments, the lenses 106-1 and 106-2 implement lens tabs at opposing lateral edges to facilitate the mechanical and electrical connection of the lens 106 to the corresponding lens receptacles 204 of the frame 104. To illustrate, referring briefly to FIGS. 4A and 4B, a rear perspective view 400 of an implementation of the lens 106-1 with lens tabs 408-1 and 408-2 at the right lateral side and left lateral side, respectively, is illustrated in accordance with embodiments. As shown, these lens tabs 408 project laterally from the body of the lens 106-1 and present a tab that can be used to facilitate a mechanical connection with a corresponding lens receptacle 204. As shown in more detail with expanded view 410 of lens tab 408-2 of FIG. 4B, one or more contact pads may be formed on a surface (the eye-facing surface 406 in this example) at the proximate terminus of each conductive trace 202 integrated into the lens 106-2. To illustrate, in the example of FIGS. 4A and 4B, the lens 106-2 includes three LDS-based conductive traces 402-1, 402-2, and 402-3 (embodiments of conductive traces 202) that primarily are formed at a top edge 412 of the lens 106-2, but at the transition from lens body to lens tab 408-2, the conductive traces 402-1, 402-2, and 402-3 are routed to the eye-facing surface 406 of the lens tab 408-2, and contact pads 414-1, 414-2, and 414-3 are formed on the eye-facing surface 406 of the lens tab 408-2 for the conductive traces 402-1, 402-2, and 402-3, respectively. Similarly, in this example, the lens 106-2 also includes four ITO-based conductive traces 402-4, 402-5, 402-6, and 402-7 that are formed at the eye-facing surface 406 of the lens 106-2, and contact pads 414-4, 414-5, 414-6, and 414-7 are formed on the eye-facing surface 406 of the lens tab 408-2 for the conductive traces 402-4, 402-5, 402-6, and 402-7, respectively. The contact pads 414 may be formed in any of a variety of manners. For LDS-based conductive traces, the corresponding contact pads may be formed using the same LDS process or using a conventional plating or other metal deposition/formation process. Likewise, for ITO-based conductive traces, the contact pads may be formed using the ITO process or using a plating or other metal deposition/formation process (e.g., by forming gold contact pads for the ITO-based conductive traces).

Note that while in this example all of the contact pads 414-1 to 414-7 are formed on the same surface 406, in other embodiments some contact pads 414 may be formed on a first surface and other contact pads formed on a second surface. To illustrate, the contact pads 414-1 to 414-3 could be formed on the opposing world-facing surface of the lens tab 408-2 and the contact pads 414-4 to 414-7 could be formed on the eye-facing surface 406. In still other embodiments, some or all of the ITO-based conductive traces 402-4 to 402-7 could be formed on the opposing world-facing surface of the lens 106-2 and thus causing the corresponding contact pads 414 to be formed on the world-facing surface of the lens tab 408-2.

With the lens tabs of the lens 106 so configured, the corresponding lens receptacles 204 can be configured so as to be mechanically and electrically coupled with the lens 106 via its lens tabs in a manner similar to printed circuit board assembly (PCBA) edge-type mating connectors, or card edge connectors. To illustrate, each of the lens receptacles 204-1 and 204-3 may be configured as a plug-in receptacle with a socket 416 dimensioned and otherwise configured to receive a corresponding lens tab 408 from the lens 106-2, and with the socket 416 containing a plurality of metal contacts 418 (e.g., pins, springs, etc.) such that the lens tab 408 and the socket 416 have a press-fit relationship to secure the lens tab 408 in the socket 416 (along with any other permanent mounting features, such as screws, bolts, adhesive, clamps, etc.) and with the metal contacts 418 making physical and electrical contact with corresponding contact pads 414 of the lens tab 408. The metal contacts 418, in turn, may be electrically connected to components of the corresponding electrical componentry 302 of the frame 104 via wiring routed between the lens receptacle 204 and the corresponding electrical componentry (e.g., via wiring routed internally through the temple 108-1 between the lens socket 204-1 and the electrical componentry 302-1).

Returning to FIGS. 1-3, with the lenses 106-1, 106-2 inserted into the corresponding lens receptacles 204-1 to 204-4, the resulting assembled eyewear device 102 provides conductive pathways for transmitting power and/or signaling between components within the frame 104 via the integrated conductive traces 202 of the lenses 106-1, 106-2. To illustrate, a conductive pathway 308-1 may be formed between the electrical componentry 302-1 of the temple 108-1 and the electrical componentry 302-2 of the temple 108-2 via the conductive trace 202-1 of the lens 106-2 and an LDS-based conductive trace 202-6 integrated in the lens 106-1, as well as via the lens receptacles 204-3 and 204-4 and corresponding internal wiring of the bridge 110 and lens receptacles 204-1 and 204-2 of the temple 108-1 and temple 108-2, respectively. Similarly, a conductive pathway 308-2 may be formed between the electrical componentry 302-1 of the temple 108-1 and the electrical componentry 302-2 of the temple 108-2 via the conductive trace 202-2 of the lens 106-2 and an LDS-based conductive trace 202-7 integrated in the lens 106-1, as well as via the lens receptacles 204-3 and 204-4 and corresponding internal wiring of the bridge 110 and lens receptacles 204-1 and 204-2 of the temple 108-1 and temple 108-2, respectively. This pair of conductive pathways 308-1 and 308-2 then may be used to, for example, supply power (e.g., VDD and GND) from the electrical componentry 302-1 of the temple 108-1 to the electrical componentry 302-2 of the temple 108-2, or vice versa. As another example, this pair of conductive pathways 308-1 and 308-2 can be used to supply power between the electrical componentry 302-1 and the electrical componentry 302-3 of the bridge 110. As yet another example, one or both of these conductive pathways 308-1 or 308-2 may be used to transmit relatively high-speed data signaling between temples 108 or between a temple 108 and the bridge 110.

As another illustrative example, a conductive pathway 308-3 may be formed between the electrical componentry 302-1 of the temple 108-1 and the electrical componentry 302-2 of the temple 108-2 via the ITO-based conductive trace 202-3 of the lens 106-2 and an ITO-based conductive trace 202-8 integrated in the lens 106-1, as well as via the lens receptacles 204-3 and 204-4 and corresponding internal wiring of the bridge 110 and lens receptacles 204-1 and 204-2 of the temple 108-1 and temple 108-2, respectively.

FIGS. 5A and 5B illustrate a left perspective view 500 and a right perspective view 501, respectively, of an alternate example configuration for a lens 506 (one embodiment of lens 106) in accordance with some embodiments. In this implementation, rather than employing lens tabs as with the lens of FIGS. 4A and 4B, the lens 506 is tab-less and instead employs solder connections for electrically coupling integrated conductive traces of the lens 506 to the lens receptacles 204 of the frame 104. As shown, the lens 506 includes one or more LDS-based conductive traces 502-1 formed on the top edge of the lens 506 and one or more ITO-based conductive traces 502-2 formed on a side surface 507 (e.g., the eye-facing surface or world-facing surface) of the lens 506. In this approach, the termini of each conductive trace 502 includes a solder pad (formed via LDS, ITO, or another plating/deposition process) that is then used to provide a soldered connection to a corresponding wire, PCB connection, or flex circuit connection of the corresponding lens receptacle 204. In this particular example, the LDS-based conductive traces 502-1 terminate on the top edge of the lens 506 while the ITO-based conductive traces 502-2 terminate on the side surface 507, thereby providing ample room for such solder connections.

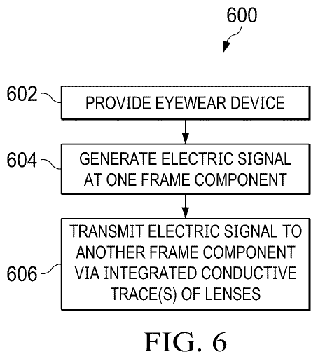

FIG. 6 illustrates a method 600 of operation of the eyewear device 102 of FIGS. 1-5B in accordance with one embodiment. The method 600 initiates with the manufacture, purchase, or other provisioning of the eyewear device 102 at block 602. At block 604, an electric component of one of the frame components (e.g., a temple 108 or the bridge 110) generates an electrical signal intended for use by one or more other electrical components of another frame component. For example, this electrical signal could be a power signal (e.g., a voltage reference) for use in powering the electrical component in the other frame component, or a data signal (e.g., a digital signal) for transmitting information to the other frame component. At block 606, the generated electrical signal is transmitted from the generating electrical component in one frame component to a receiving electrical component in a different frame component via a conductive pathway that includes an integrated conductive trace patterned or otherwise formed on at least one surface of an optical lens 106 of the eyewear device 102. The electrical signal is received by the receiving electrical component via this conductive trace and is utilized or processed accordingly.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is set forth in the claims below.

What is claimed is:

1. An eyewear device comprising:
a support frame comprising a first frame component and a second frame component, the first frame component housing a first electrical component;
a first optical element mechanically coupled to the first frame component at a first side and to the second frame component at an opposing second side; and
a first conductive trace disposed at a first surface of the first optical element and electrically coupled to the first electrical component, the first conductive trace extending across the first optical element between the first side and the second side to provide a first conductive pathway between the first frame component and the second frame component.

2. The eyewear device of claim 1, further comprising:
the support frame further comprising a third frame component housing a second electrical component;
a second optical element mechanically coupled to the second frame component at a third side and to the third frame component at an opposing fourth side;
a second conductive trace disposed at a second surface of the second optical element, the second conductive trace extending across the second optical element between the third side and the fourth side to provide a second conductive pathway between the second frame component and the third frame component; and
wherein the first conductive trace, the second conductive trace, and the second frame component provide a third conductive pathway between the first electrical component and the second electrical component.

3. The eyewear device of claim 2, wherein the first frame component is a first temple, the second frame component is a bridge, the third frame component is a second temple, the first optical element and the second optical element each include at least one of a lens or a waveguide.

4. The eyewear device of claim 3, wherein the support frame has a rimless or semi-rimless form factor lacking an encapsulating rim around the first optical element.

5. The eyewear device of claim 2, wherein the first electrical component is a battery and the second electrical component is one of a processing system, a sensor, or a display.

6. The eyewear device of claim 1, wherein the second frame component houses a second electrical component, and the first conductive pathway is configured to transmit one or both of power or data signaling between the first electrical component and the second electrical component.

7. The eyewear device of claim 6, wherein the first frame component is a temple and the second frame component is a bridge.

8. The eyewear device of claim 1, further comprising:
a second conductive trace disposed at a second surface of the first optical element, the second conductive trace extending across the first optical element between the first side and the second side to provide a second conductive pathway between the first frame component and the second frame component.

9. The eyewear device of claim 8, wherein:
the first conductive trace comprises a conductive trace patterned on the first surface using a laser direct structuring (LDS) process; and
the second conductive trace comprises a conductive trace patterned on the second surface using Indium Tin Oxide.

10. The eyewear device of claim 1, wherein:
the first optical element comprises a first lens tab at the first side, the first lens tab comprising a first contact pad for the first conductive trace; and
the first frame component includes a first receptacle comprising a first socket with a plurality of metal contacts, the first socket configured to mechanically couple with the first lens tab with a metal contact in physical contact with the first contact pad.

11. The eyewear device of claim 10, wherein:
the first optical element comprises a second lens tab at the second side, the second lens tab comprising a second contact pad for the first conductive trace; and
the second frame component includes a second receptacle comprising a second socket with a plurality of metal contacts, the second socket configured to mechanically couple with the second lens tab with a metal contact in physical contact with the second contact pad.

12. The eyewear device of claim 1, wherein:
the first conductive trace comprises a solder pad disposed at the first side of the first optical element; and
the first electrical component is coupled to the first conductive trace via a soldered connection to the solder pad.

13. The eyewear device of claim 1, wherein the first frame component is a temple and the second frame component is a bridge.

14. The eyewear device of claim 1, wherein the support frame has a rimless or semi-rimless form factor lacking an encapsulating rim around the first optical element.

15. The eyewear device of claim 1, wherein the first conductive trace comprises a conductive trace patterned on the first surface using a laser direct structuring (LDS) process.

16. The eyewear device of claim 1, wherein the first conductive trace comprises a conductive trace patterned on the first surface using Indium Tin Oxide (ITO).

17. A method of operating an eyewear device, comprising:
providing an eyewear device having a first temple, a second temple, a bridge, and a first optical element disposed between the first temple and the bridge and including a first conductive trace disposed at a surface of the first optical element and extending from a first side to a second side of the first optical element; and
transmitting an electrical signal between a first electrical component housed in the first temple and a second electrical component housed in one of the bridge or the second temple via the first conductive trace.

18. The method of claim 17, wherein:
providing the eyewear device further comprises providing the eyewear device with a second optical element disposed between the bridge and the second temple and including a second conductive trace disposed at a surface of the second optical element and extending from a third side to a fourth side of the second optical element;
the second electrical component is housed in the second temple; and
transmitting the electrical signal between the first electrical component and the second electrical component comprises transmitting the electrical signal via the first conductive trace and the second conductive trace.

19. The method of claim 17, wherein the first conductive trace comprises a conductive trace patterned on the surface using a laser direct structuring (LDS) process or using Indium Tin Oxide.

20. The method of claim 17, wherein the first conductive trace comprises a conductive trace patterned on the surface using Indium Tin Oxide.
